(19) United States
(12) Patent Application Publication
(10) Pub. No.: US 2023/0271879 A1
(43) Pub. Date: Aug. 31, 2023

(54) CHEMICALLY STRENGTHENED GLASS AND METHOD FOR MANUFACTURING THE SAME

(71) Applicant: AGC Inc., Tokyo (JP)

(72) Inventors: Yusuke FUJIWARA, Tokyo (JP); Yoichi TAKATO, Tokyo (JP); Yusuke KOBAYASHI, Tokyo (JP)

(73) Assignee: AGC Inc., Tokyo (JP)

(21) Appl. No.: 18/174,179

(22) Filed: Feb. 24, 2023

(30) Foreign Application Priority Data
Feb. 28, 2022 (JP) 2022-029883

(51) Int. Cl. C03C 21/00; C03C 10/00

(52) U.S. Cl. CPC C03C 21/002; C03C 10/0027

(57) ABSTRACT

The present invention relates to a chemically strengthened glass, satisfying: a ratio ICS (≥400)/ICS being more than 0.13 in a stress profile, the ICS representing an integrated value of compressive stress in a region from a surface of the glass to a depth where the compressive stress becomes 0 in the stress profile, and the ICS (≥400) representing an integrated value of compressive stress in a region from a depth of 400 μm from the surface of the glass to the depth where the compressive stress becomes 0 in the stress profile.

### CROSS-REFERENCE TO RELATED APPLICATIONS

This application claims priority from Japanese Patent Application No. 2022-029883 filed on Feb. 28, 2022, the entire subject matter of which is incorporated herein by reference.

### TECHNICAL FIELD

The present invention relates to a chemically strengthened glass and a method for manufacturing the same. Specifically, the present invention relates to a chemically strengthened glass suitable for protecting a sensor module and a sensor or vibrator and a method for manufacturing the same.

### BACKGROUND ART

A plurality of sensors having various functions are mounted on a car, an electric train, mobile equipment such as a drone, and a security device such as an outdoor sensor or a surveillance camera. The use of the sensor may be hindered depending on the structure or material of a protective member and therefore, the type of the sensor disposed inside the protective member is also a factor in selecting the structure or material of the protective member.

As the protective member for protecting the sensor, it is preferable to select a material having a high visible-light-transmitting property and having high strength. A sensor module containing glass as the protective member for protecting the sensor is known and, for example, Patent Document 1 discloses a sensor module containing a chemically strengthened glass as the protective member.

A chemically strengthened glass is obtained by forming a compressive stress layer in a glass surface portion through an ion exchange treatment of bringing a glass into contact with an inorganic salt composition such as sodium nitrate and potassium nitrate. In the ion exchange treatment, an ion exchange occurs between alkali metal ions contained in the glass and alkali metal ions having a large ionic radius contained in the inorganic salt composition, and a compressive stress layer is thereby formed in a glass surface portion. The strength of the chemically strengthened glass depends on a stress profile represented by a compressive stress (hereinafter, also abbreviated as CS) using, as a variable, the depth from a surface of the glass.
Patent Document 1: WO2019/009336

### SUMMARY OF INVENTION

In the case of mounting a sensor on mobile equipment, a foreign matter of a flying stone or the like may collide with a sensor module during running. Like this, in the case where an external momentary impact is applied thereto by the collision with the flying stone or the like, the stress at the time of the collision is not relieved and a concentrated stress is generated, which may break the glass as a protective member and the sensor. For this reason, the glass for protecting the sensor is required to have excellent resistance to flying stones.

Accordingly, an object of the present invention is to provide a chemically strengthened glass exhibiting more excellent resistance to flying stones than before and a method for manufacturing the same.

As a result of studies on the object above, the present inventors have found that the resistance to flying stones can be enhanced by a chemically strengthened glass having a specific stress profile in which a compressive stress in a deep layer portion at a depth of 400 μm or more from a surface of the glass is increased. The present invention has been accomplished based on this finding.

The present invention relates to a chemically strengthened glass in which a ratio ICS (≥400)/ICS is more than 0.13 in a stress profile, the ICS represents an integrated value of compressive stress in a region from a surface of the glass to a depth where the compressive stress becomes 0 in the stress profile, and the ICS (≥400) represents an integrated value of compressive stress in a region from a depth of 400 μm from the surface of the glass to the depth where the compressive stress becomes 0 in the stress profile.

In addition, the present invention relates to a method for manufacturing a chemically strengthened glass, including performing a first ion exchange of exchanging ions by bringing a lithium-containing aluminosilicate glass having a sheet thickness of 1.4 to 7 mm into contact with a first inorganic salt composition containing sodium at a temperature of 430° C. or higher for 10 hours or longer.

The chemically strengthened glass of the present invention has a specific stress profile in which a compressive stress in the deep layer portion at the depth of 400 μm or more from a surface of the glass is high, and therefore, exhibits excellent resistance to flying stones. According to the method for manufacturing a chemically strengthened glass of the present invention, a lithium-containing aluminosilicate glass having a sheet thickness of 1.4 mm or more is subjected to an ion exchange under specific conditions, and this enables to increase a compressive stress in the deep layer portion at the depth of 400 μm or more from a surface of the glass and to manufacture a chemically strengthened glass exhibiting excellent resistance to flying stones.

### BRIEF DESCRIPTION OF DRAWINGS

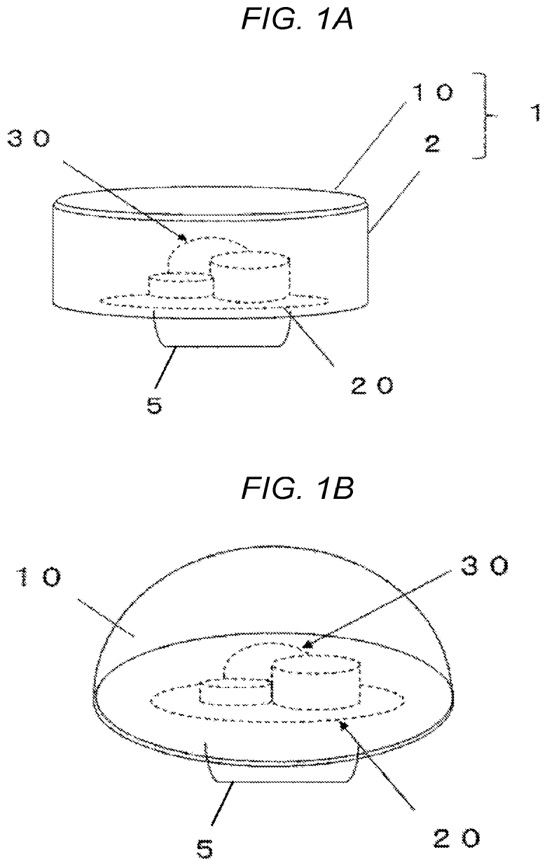

Each of FIGS. 1A and 1B is a perspective view illustrating a configuration example of a protective member formed with a chemically strengthened glass according to an embodiment of the present invention as a part or the entirety.

### DESCRIPTION OF EMBODIMENTS

The present invention is described in detail below, but the invention is not limited to the following embodiments and can be implemented arbitrarily making modifications therein without departing from the gist of the invention.

In the present specification, the symbol “-” or the word “to” that is used to express a numerical range includes the numerical values before and after the symbol or the word as the upper limit and the lower limit of the range, respectively. Also, in the specification, unless otherwise specified, the composition (content of each component) of the glass is represented by molar percentage in terms of oxides.

In the following, the “chemically strengthened glass” refers to a glass after a chemical strengthening treatment, and the “glass for chemical strengthening” refers to a glass before the chemical strengthening treatment.

In the specification, unless otherwise specified, the glass composition is represented by mol % in terms of oxides, and mol % is simply denoted as “%”. Also, in the specification, the expression “substantially free of” means the content of a component is lower than or equal to an impurity level contained in raw materials and the like, that is, the component is not added thereto intentionally. Specifically, for example, the content is lower than 0.1%.

In the specification, the “stress profile” refers to a profile showing compressive stress values with a depth from a surface of the glass as a variable. In the stress profile, tensile stress is represented as a negative compressive stress.

The “compressive stress (CS)” can be measured as follows: a cross-section surface of the glass is worked into thin pieces; and a sample subjected to the thin pieces is analyzed by a birefringence imaging system. A birefringence meter in the birefringence imaging system is a device for measuring the magnitude of retardation generated due to stress by using a polarizing microscope and a liquid crystal compensator, etc., and examples thereof include Birefringence Imaging System Abrio-IM manufactured by CRi, Inc.

In some cases, the compressive stress can also be measured utilizing scattered light photoelasticity. In this method, CS can be measured by causing light to be incident into the surface of the glass and analyzing polarization of scattered light. Examples of the stress meter utilizing scattered light photoelasticity include Scattered Light Photoelastic Stress Meter SLP-manufactured by Orihara Manufacturing Co., Ltd.

In the specification, the “depth of compressive stress layer (DOC)” is a depth where the compressive stress value becomes 0. In the following, the surface compressive stress value and the compressive stress value at a depth of 50 μm from the surface are sometimes denoted as CS₀ and CS₅₀, respectively. In addition, the “internal tensile stress (CT)” refers to a tensile stress value at a depth corresponding to ½ of a sheet thickness t.

In the specification, a crack generation rate is evaluated under the following conditions in accordance with the strength test method of ISO 20567-1 Test Method B.

### (Conditions)

Flying stone: chilled iron grit
Stone size: 3.55-5 mm
Ejection amount: 500 g
Ejection pressure: 250 kPa
Sample setting angle: 54°
Ejection time: 8-12 seconds
Number of ejections: 2
Sample collision area: 40-40 mm

<Stress Measurement Method>

In recent years, a main type of glass for a cover glass of smartphones, etc. is obtained by conducting chemical strengthening by two steps of: exchanging lithium ions inside glass with sodium ions (Li—Na exchange); and thereafter, exchanging sodium ions inside the glass with potassium ions (Na—K exchange) in a surface layer portion of the glass.

For acquiring nondestructively the stress profile of such a two-step chemically strengthened glass, for example, Scattered Light Photoelastic Stress Meter (hereinafter, sometimes simply referred as SLP) or glass surface stress meter (Film Stress Measurement; hereinafter, sometimes simply referred to as FSM) may be used in combination.

In the method using a scattered light photoelastic stress meter (SLP), a compressive stress derived from the Li—Na exchange can be measured in the inside of the glass at dozens of μm or more from a surface layer of the glass. On the other hand, in the method using a glass surface stress meter (FSM), a compressive stress derived from the Na—K exchange can be measured in the glass surface layer portion at dozens of μm or less from the surface of the glass (see, for example, WO2018/056121 and WO2017/115811). Accordingly, for the two-step chemically strengthened glass, a synthesized profile of SLP information and FSM information is sometimes used as a stress profile in the surface layer of the glass and the inside thereof.

In the invention, the stress profile measured by scattered light photoelastic stress meter (SLP) is mainly used. Incidentally, in the specification, in the case where compressive stress CS, tensile stress CT, depth of compressive stress layer DOC, etc. are used, these indicate the values in the SLP stress profile.

The scattered light photoelastic stress meter is a stress measuring device including: a polarization phase difference-varying member for varying a polarization phase difference of a laser light by one wavelength or more with respect to a wavelength of the laser light; an imaging device for acquiring a plurality of images by imaging, at predetermined time intervals by a plurality of times, a scattered light generated when the laser light with the polarization phase difference being varied enters a strengthened glass; and a computing unit for measuring a periodic luminance change of the scattered light by using the plurality of images, computing a phase change in the luminance change, and based on the phase change, computing a stress distribution in a depth direction from a surface of the chemically strengthened glass.

A method for measuring a stress profile by using the scattered light photoelastic stress meter includes the method described in WO2018/056121. Examples of the scattered light photoelastic stress meter include SLP-1000 and SLP-2000 manufactured by Orihara Manufacturing Co., Ltd. An attached Software SlpIV_up3 (Ver. 2019.01.10.001) combined with these scattered light photoelastic stress meters enables a highly accurate stress measurement.

In the specification, an average slope of the stress profile refers to an average obtained by determining a slope of a stress profile every 1 μm within a depth range in which the slope is determined.

<Chemically Strengthened Glass>

### <<Stress Profile>>

The chemically strengthened glass of this embodiment (hereinafter, also abbreviated as the present chemically strengthened glass) is characterized in that a ratio ICS (≥400)/ICS is more than 0.13, where the ICS represents an integrated value of compressive stress in a region from a surface of the glass to a depth where the compressive stress becomes 0 in the stress profile, and the ICS (≥400) represents an integrated value of compressive stress in a region from a depth of 400 μm from the surface of the glass to the depth where the compressive stress becomes 0 in the stress profile. The ratio ICS (≥400)/ICS is a ratio of the ICS (≥400) with respect to the ICS. In the case where the ratio ICS (≥400)/ICS is more than 0.13, the compressive stress at a position deeper than the depth of 400 μm or more from the surface is increased, and excellent resistance to flying stones is exhibited.

In the present chemically strengthened glass, ICS (≥400)/ICS is more than 0.13, preferably 0.16 or more, more preferably 0.19 or more, still more preferably 0.22 or more, and most preferably 0.25 or more. The upper limit of ICS (≥400)/ICS is not particularly limited but, from the viewpoint of balance with the surface layer stress, is preferably 0.8 or less, more preferably 0.7 or less.

In the present chemically strengthened glass, the integrated value ICS (≥400) of compressive stress in the region from the depth of 400 μm from the surface to the depth where the compressive stress becomes 0 is preferably 9,200 MPa·μm or more, more preferably 9,800 MPa·μm or more, still more preferably 10,400 MPa·μm or more, yet still more preferably 11,000 MPa·μm or more. In the case where ICS (≥400) is 9,200 MPa·μm or more, the compressive stress at the position deeper than the depth of 400 μm or more from the surface can be increased to enhance the resistance to flying stones more. Also, from the viewpoint of productivity, ICS (≥400) is preferably 40,000 or less, more preferably 35,000 or less, still more preferably 30,000 or less.

In the present chemically strengthened glass, a stress layer depth DOL where the compressive stress becomes 50 MPa is preferably 400 μm or more, more preferably 450 μm or more, still more preferably 500 μm or more, yet still more preferably 550 μm or more. In the case where the stress layer depth DOL where the compressive stress becomes 50 MPa is μm or more, the compressive stress at the position deeper than the depth of 400 μm or more from the surface can be increased to enhance the resistance to flying stones more. The upper limit of the stress layer depth DOL where the compressive stress becomes 50 MPa is not particularly limited but, from the viewpoint of balance between compressive stress and tensile stress, usually, is preferably 1,000 μm or less.

In the present chemically strengthened glass, a negative maximum slope of a stress profile at a position deeper than 50 μm from the surface is preferably −0.50 (MPa/μm) or more, more preferably −0.46 (MPa/μm) or more, still more preferably −0.42 (MPa/μm) or more. In the case where the negative maximum slope of the stress profile at the position deeper than 50 μm from the surface is −0.50 (MPa/μm) or more, the compressive stress in a deep layer portion can be increased to enhance the resistance to flying stones more. The upper limit of the negative maximum slope is not particularly limited but, from the viewpoint of enhancing a bending strength attributed to the surface layer stress, is preferably −0.05 (MPa/μm) or less, more preferably −0.09 (MPa/μm) or less.

In the present chemically strengthened glass, a sheet thickness is represented as t, and a value DOC/t obtained by dividing a depth of a compressive stress layer DOC by t is preferably 0.170 or more, more preferably 0.175 or more, still more preferably 0.180 or more, yet still more preferably 0.185 or more. In the case where DOC/t is 0.170 or more, the compressive stress in the deep layer portion can be increased to enhance the resistance to flying stones more. The upper limit of DOC/t is not particularly limited but, from the viewpoint of balance between compressive stress and tensile stress, is preferably 0.30 or less, more preferably 0.28 or less.

In the present chemically strengthened glass, from the viewpoint of enhancing the strength, a maximum tensile stress CTmax is preferably 40 MPa or more, more preferably 45 MPa or more, still more preferably 50 MPa or more, yet still more preferably 55 MPa or more. The upper limit of the maximum tensile stress CTmax is not particularly limited but, from the viewpoint of productivity, usually, is preferably 100 MPa or less.

In the present chemically strengthened glass, a compressive stress CS₄₀₀ at a depth of 400 μm from the surface is preferably 60 MPa or more, more preferably 65 MPa or more, still more preferably 70 MPa or more, yet still more preferably 75 MPa or more. In the case where CS₄₀₀ is 60 MPa or more, the compressive stress in the deep layer portion can be increased to enhance the resistance to flying stones more. The upper limit of CS₄₀₀ is not particularly limited but, from the viewpoint of balance between compressive stress and tensile stress, usually, is preferably 200 MPa or less.

In the present chemically strengthened glass, a compressive stress CS₅₀₀ at a depth of 500 μm from the surface is preferably 45 MPa or more, more preferably 50 MPa or more, still more preferably 55 MPa or more, yet still more preferably 60 MPa or more. In the case where CS₅₀₀ is 45 MPa or more, the compressive stress in the deep layer portion can be increased to enhance the resistance to flying stones more. The upper limit of CS₅₀₀ is not particularly limited but, from the viewpoint of balance between compressive stress and tensile stress, usually, is preferably 180 MPa or less.

In the present chemically strengthened glass, a compressive stress CS₆₀₀ at a depth of 600 μm from the surface is preferably 15 MPa or more, more preferably 20 MPa or more, still more preferably 25 MPa or more, yet still more preferably 30 MPa or more. In the case where CS₆₀₀ is 15 MPa or more, the compressive stress in the deep layer portion can be increased to enhance the resistance to flying stones more. The upper limit of CS₆₀₀ is not particularly limited but, from the viewpoint of balance between compressive stress and tensile stress, usually, is preferably 160 MPa or less.

As specific examples of the present chemically strengthened glass, stress profiles of the chemically strengthened glasses of the first embodiment and the second embodiment are described below. Incidentally, the above-described characteristics of the stress profile of the present chemically strengthened glass are shared between the first embodiment and the second embodiment. The characteristics in the stress profile of the present chemically strengthened glass can be adjusted by its base composition and the conditions of ion exchange treatment.

(Chemically Strengthened Glass of First Embodiment)

In the chemically strengthened glass of the first embodiment, a negative maximum slope of a stress profile at a depth of 0 to 20 μm from the surface is preferably −10 (MPa/μm) or less, more preferably −12 (MPa/μm) or less, still more preferably −14 (MPa/μm) or less, yet still more preferably −16 (MPa/μm) or less. In the case where the negative maximum slope of the stress profile at a depth of 0 to 20 μm is −10 (MPa/μm) or less, an extra stress not contributing to the strength can be reduced. The lower limit of the negative maximum slope is not particularly limited but, from the viewpoint of enhancing a deep layer portion stress, usually, is preferably −40 (MPa/μm) or more.

The stress profile of the chemically strengthened glass of the first embodiment has a local maximum. The compressive stress value at the local maximum is preferably 50 MPa or more, more preferably 60 MPa or more, still more preferably 70 MPa or more, yet still more preferably 80 MPa or more. In the case where the compressive stress value at the local maximum is 50 MPa or more, crack development in the deep layer portion can be inhibited to enhance the resistance to flying stones more. The upper limit of the compressive stress value at the local maximum is not particularly limited but, from the viewpoint of balance between compressive stress and tensile stress, usually, is preferably 200 MPa or less.

In the chemically strengthened glass of the first embodiment, a sheet thickness is represented as t, and the local maximum positions preferably within a range of 0.05 t to 0.13 t in a depth from the surface. The local maximum positions more preferably within a range of 0.055 t or more, still more preferably within a range of 0.060 t or more, yet still more preferably within a range of 0.065 t or more. Also, the local maximum positions more preferably within a range of 0.12 t or less, still more preferably within a range of 0.11 t or less, yet still more preferably within a range of 0.10 t or less. In the case where the local maximum positions within the range of 0.05 t to 0.13 t, the compressive stress in the deep layer portion can be increased to enhance the resistance to flying stones more.

In the chemically strengthened glass of the first embodiment, preferably a relationship of ms>md is satisfied, where the ms represents an absolute value of an average slope of the stress profile in a region from the surface to the local maximum, and the and represents an absolute value of an average slope of the stress profile from the local maximum to the depth where the compressive stress becomes 0. In the case where ms>md is satisfied, the compressive stress in the deep layer portion can be increased to enhance the resistance to flying stones more.

In the chemically strengthened glass of the first embodiment, a ratio CS₄₀₀/CS₀ of a compressive stress CS₄₀₀ at a depth of 400 μm from the surface to a surface compressive stress CS₀ is preferably 0.10 or more, more preferably 0.12 or more, still more preferably 0.14 or more, yet still more preferably 0.16 or more. In the case where CS₄₀₀/CS₀ is 0.10 or more, the compressive stress in the deep layer portion can be increased to enhance the resistance to flying stones more. The upper limit of CS₄₀₀/CS₀ is not particularly limited but, from the viewpoint of enhancing the bending strength attributed to the surface layer stress, usually, is preferably 0.50 or less.

In the chemically strengthened glass of the first embodiment, from the viewpoint of enhancing the bending strength, the surface compressive stress CS₀ is preferably 400 MPa or more, more preferably 450 MPa or more, still more preferably 500 MPa or more. From the viewpoint of balance between compressive stress and tensile stress, the surface compressive stress CS₀ is preferably 900 MPa or less, more preferably 800 MPa or less, still more preferably 700 MPa or less.

In the chemically strengthened glass of the first embodiment, a ratio CS₆₀₀/CS₀ of a compressive stress CS₆₀₀ at a depth of 600 μm from the surface to a compressive stress CS₀ at a depth of 0 μm from the surface (i.e. the surface compressive stress CS₀) is preferably 0.03 or more, more preferably 0.04 or more, still more preferably 0.05 or more, yet still more preferably 0.06 or more. In the case where CS₆₀₀/CS₀ is 0.03 or more, the compressive stress in the deep layer portion can be increased to enhance the resistance to flying stones more. The upper limit of CS₆₀₀/CS₀ is not particularly limited but, from the viewpoint of enhancing the bending strength attributed to the surface layer stress, usually, is preferably 0.20 or less.

(Chemically Strengthened Glass of Second Embodiment) In the chemically strengthened glass of the second embodiment, the ratio CS₄₀₀/CS₀ of the compressive stress CS₄₀₀ at a depth of 400 μm from the surface to the surface compressive stress CS₀ is preferably 0.32 or more, more preferably 0.34 or more, still more preferably 0.36 or more, yet still more preferably 0.38 or more. In the case where CS₄₀₀/CS₀ is 0.32 or more, the compressive stress in the deep layer portion can be increased to enhance the resistance to flying stones more. The upper limit of CS₄₀₀/CS₀ is not particularly limited but, from the viewpoint of enhancing the bending strength attributed to the surface layer stress, usually, is preferably 0.50 or less.

In the chemically strengthened glass of the second embodiment, from the viewpoint of enhancing the strength, the surface compressive stress CS₀ is preferably 200 MPa or more, more preferably 210 MPa or more, still more preferably 220 MPa or more. Also, from the viewpoint of increasing the stress in the deep layer portion, the surface compressive stress CS₀ is preferably 320 MPa or less, more preferably 310 MPa or less, still more preferably 300 MPa or less.

In the chemically strengthened glass of the second embodiment, the ratio CS₆₀₀/CS₀ of the compressive stress CS₆₀₀ at the depth of 600 μm from the surface to the surface compressive stress CS₀ is preferably 0.03 or more, more preferably 0.04 or more, still more preferably 0.05 or more, yet still more preferably 0.06 or more. In the case where CS₆₀₀/CS₀ is 0.03 or more, the compressive stress in the deep layer portion can be increased to enhance the resistance to flying stones more. The upper limit of CS₆₀₀/CS₀ is not particularly limited but, from the viewpoint of enhancing the bending strength attributed to the surface layer stress, usually, is preferably 0.20 or less.

<<Crack Generation Rate>>

In the present chemically strengthened glass, a crack generation rate evaluated in accordance with a strength test method of ISO 20567-1 Test Method B is preferably 10% or less, more preferably 8% or less, still more preferably 5% or less, yet still more preferably 3% or less. In the case where the crack generation rate is 10% or less, the resistance to flying stones can be increased more effectively. In the case of determining the crack generation rate, n is 3 or more.

<<Sheet Thickness>>

In the present chemically strengthened glass, a sheet thickness is preferably 1.4 to 7 mm. From the viewpoint of enhancing the strength, the sheet thickness is more preferably 1.8 mm or more, still more preferably 2.2 mm or more, yet still more preferably 2.6 mm or more. From the viewpoint of achieving weight saving, the sheet thickness is more preferably 6.6 mm or less, still more preferably 6.2 mm or less, yet still more preferably 5.8 mm or less.

<<Glass Composition>>

In the present specification, “the base composition of the chemically strengthened glass” is a glass composition of the glass for chemical strengthening, and except for a case that an extreme ion exchange treatment is performed, a glass composition in a portion deeper than the depth of the compressive stress layer in the chemically strengthened glass is substantially the same as the base composition of the chemically strengthened glass.

In the chemically strengthened glass of this embodiment, the base composition preferably contains, in mol % in terms of oxides,
52 to 75% of SiO₂,
8 to 20% of Al₂O₃, and
5 to 18% of Li₂O.

In the chemically strengthened glass of this embodiment, the base composition more preferably contains, in mol % in terms of oxides,
52 to 75% of SiO₂,
8 to 20% of Al₂O₃,
5 to 18% of Li₂O,
0 to 15% of Na₂O,
0 to 5% of K₂O,
0 to 20% of MgO,
0 to 20% of CaO,
0 to 20% of SrO,
0 to 20% of BaO,
0 to 10% of ZnO,
0 to 1% of TiO₂,
0 to 8% of ZrO₂, and
0 to 5% of Y₂O₃.

A preferable base composition of the glass is described below.

In the glass for chemical strengthening of this embodiment, SiO₂ is a component for forming a network structure of the glass. In addition, this is a component for increasing the chemical durability. The content of SiO₂ is preferably 52% or more, more preferably 56% or more, still more preferably 60% or more, yet still more preferably 64% or more. On the other hand, in order to improve the meltability, the content of SiO₂ is preferably 75% or less, more preferably 73% or less, still more preferably 71% or less, yet still more preferably 69% or less.

Al₂O₃ is a component for increasing the surface compressive stress due to chemical strengthening and is essential. The content of Al₂O₃ is preferably 8% or more, more preferably 10% or more, still more preferably 11% or more, yet still more preferably 12% or more. On the other hand, in order to prevent an excessive rise in devitrification temperature of the glass, the content of Al₂O₃ is preferably 20% or less, more preferably 18% or less, still more preferably 17% or less, yet still more preferably 16% or less, and most preferably 15% or less.

Li₂O is a component for forming a surface compressive stress through ion exchange. The content of Li₂O is preferably 5% or more, more preferably 7% or more, still more preferably 9% or more, yet still more preferably 11% or more. On the other hand, in order to stabilize the glass, the content of Li₂O is preferably 18% or less, more preferably 17% or less, still more preferably 16% or less, and most preferably 15% or less.

MgO is a component for stabilizing the glass and also is a component for increasing the mechanical strength and chemical resistance and therefore, in the case where the content of Al₂O₃ is relatively small, MgO is preferably contained. The content of MgO is preferably 1% or more, more preferably 2% or more, still more preferably 3% or more, yet still more preferably 4% or more. On the other hand, if MgO is excessively added thereto, the viscosity of the glass decreases to readily cause devitrification or phase separation. The content of MgO is preferably 20% or less, more preferably 19% or less, still more preferably 18% or less, yet still more preferably 17% or less.

Each of CaO, SrO, BaO and ZnO is a component for enhancing the meltability of the glass and may be contained.

CaO is a component for enhancing the meltability of the glass and also is a component for improving the crushability of the chemically strengthened glass, and CaO may be contained. In the case of containing CaO, the content thereof is preferably 0.5% or more, more preferably 1% or more, still more preferably 2% or more, yet still more preferably 3% or more, and most preferably 5% or more. On the other hand, in the case where the content of CaO exceeds 20%, the ion exchange performance is significantly reduced. Therefore, the content of CaO is preferably 20% or less. The content of CaO is more preferably 14% or less, still more preferably, stepwise, 10% or less, 8% or less, 6% or less, 3% or less, or 1% or less.

SrO is a component for enhancing the meltability of the glass and also is a component for improving the crushability of the chemically strengthened glass, and SrO may be contained. In the case of containing SrO, the content thereof is preferably 0.5% or more, more preferably 1% or more, still more preferably 2% or more, yet still more preferably 3% or more, and most preferably 5% or more. On the other hand, in the case where the content of SrO exceeds 20%, the ion exchange performance is significantly reduced. Therefore, the content of SrO is preferably 20% or less. The content of SrO is more preferably 14% or less, still more preferably, stepwise, 10% or less, 8% or less, 6% or less, 3% or less, or 1% or less.

BaO is a component for enhancing the meltability of the glass and also is a component for improving the crushability of the chemically strengthened glass, and BaO may be contained. In the case of containing BaO, the content thereof is preferably 0.5% or more, more preferably 1% or more, still more preferably 2% or more, yet still more preferably 3% or more, and most preferably 5% or more. On the other hand, in the case where the content of BaO exceeds 20%, the ion exchange performance is significantly reduced. The content of BaO is preferably 15% or less, more preferably, stepwise, 10% or less, 8% or less, 6% or less, 3% or less, or 1% or less.

ZnO is a component for enhancing the meltability of the glass and may be contained. In the case of containing ZnO, the content thereof is preferably 0.25% or more, more preferably 0.5% or more. On the other hand, in the case where the content of ZnO exceeds 10%, the weather resistance of the glass is significantly reduced. The content of ZnO is preferably 10% or less, more preferably 8% or less, stepwise, 6% or less, 3% or less, or 1% or less.

Na₂O is a component for enhancing the meltability of the glass. Na₂O is not essential but in the case of containing Na₂O, the content thereof is preferably 1% or more, more preferably 2% or more, still more preferably 5% or more. In the case where the content of Na₂O is too large, the chemical strengthening properties are deteriorated. Therefore, the content of Na₂O is preferably 15% or less, more preferably 12% or less, still more preferably 10% or less, and most preferably 8% or less.

K₂O is, as with Na₂O, a component for lowering the melting temperature of the glass and may be contained. In the case of containing K₂O, the content thereof is preferably 0.5% or more, more preferably 0.8% or more, still more preferably 1% or more, yet still more preferably 1.2% or more, even yet still more preferably 1.5% or more. In the case where the content of K₂O is too large, the chemical strengthening properties are deteriorated and also, the chemical durability decreases. Therefore, the content of K₂O is preferably 5% or less, more preferably 4.8% or less, still more preferably 4.5% or less, yet still more preferably 4.2% or less, and most preferably 4.0% or less.

In order to enhance the meltability of glass raw materials, the total content Na₂O+K₂O of Na₂O and K₂O is preferably 3% or more, more preferably 5% or more. In addition, in the case where with respect to the total content of Li₂O, Na₂O and K₂O (hereinafter, referred to as R₂O), a ratio K₂O/R₂O of the content of K₂O is 0.2 or less, the chemical strengthening properties can be enhanced and the chemical durability can be increased, which is preferable. K₂O/R₂O is more preferably 0.15 or less, still more preferably 0.10 or less. Incidentally, R₂O is preferably 10% or more, more preferably 12% or more, still more preferably 15% or more. Also, R₂O is preferably 20% or less, more preferably 18% or less.

ZrO₂ is a component for increasing the mechanical strength and chemical durability and significantly enhances CS and therefore, ZrO₂ is preferably contained. The content of ZrO₂ is preferably 0.5% or more, more preferably 0.7% or more, still more preferably 1.0% or more, yet still more preferably 1.2% or more, and most preferably 1.5% or more. On the other hand, in order to suppress devitrification during melting, the content of ZrO₂ is preferably 8% or less, more preferably 7.5% or less, still more preferably 7% or less, yet still more preferably 6% or less. In the case where the content of ZrO₂ is too large, the viscosity decreases due to a rise in the devitrification temperature. In order to suppress deterioration of the moldability due to such a decrease in the viscosity, in the case where the molding viscosity is low, the content of ZrO₂ is preferably 5% or less, more preferably 4.5% or less, still more preferably 3.5% or less.

In order to increase the chemical durability, ZrO₂/R₂O is preferably 0.02 or more, more preferably 0.04 or more, still more preferably 0.06 or more, yet still more preferably 0.08 or more, and most preferably 0.1 or more. ZrO₂/R₂O is preferably 0.2 or less, more preferably 0.18 or less, still more preferably 0.16 or less, yet still more preferably 0.14 or less.

TiO₂ is not essential but in the case of containing this component, the content thereof is preferably 0.05% or more, more preferably 0.1% or more. On the other hand, in order to suppress devitrification during melting, the content of TiO₂ is preferably 1% or less, more preferably 0.5% or less, still more preferably 0.3% or less.

SnO₂ is not essential but in the case of containing this component, the content thereof is preferably 0.5% or more, more preferably 1% or more, still more preferably 1.5% or more, yet still more preferably 2% or more. On the other hand, in order to suppress devitrification during melting, the content of SnO₂ is preferably 4% or less, more preferably 3.5% or less, still more preferably 3% or less, yet still more preferably 2.5% or less.

Y₂O₃ is a component for making fragments less likely to scatter when the chemically strengthened glass is broken, and may be contained. The content of Y₂O₃ is preferably 0.3% or more, more preferably 0.5% or more, still more preferably 0.7% or more, yet still more preferably 1.0% or more. On the other hand, in order to suppress devitrification during melting, the content of Y₂O₃ is preferably 5% or less, more preferably 4% or less.

B₂O₃ is a component for enhancing the chipping resistance of the glass for chemical strengthening or the chemically strengthened glass and also is a component for enhancing the meltability, and B₂O₃ may be contained. In the case of containing B₂O₃, in order to enhance the meltability, the content thereof is preferably 0.5% or more, more preferably 1% or more, still more preferably 2% or more. On the other hand, in the case where the content of B₂O₃ is too large, it is likely that formation of striae or phase separation occurs during melting to deteriorate the quality of the chemically strengthened glass. Therefore, the content of B₂O₃ is preferably 10% or less. The content of B₂O₃ is more preferably 8% or less, still more preferably 6% or less, yet still more preferably 4% or less.

Each of La₂O₃, Nb₂O₅ and Ta₂O₅ is a component for making fragments less likely to scatter when the chemically strengthened glass is broken, and may be contained in order to increase the refractive index. In the case of containing these components, the total content (hereinafter, La₂O₃+Nb₂O₅+Ta₂O₅) of La₂O₃, Nb₂O₅ and Ta₂O₅ is preferably 0.5% or more, more preferably 1% or more, still more preferably 1.5% or more, yet still more preferably 2% or more. Also, in order to make the glass less likely to devitrify during melting, La₂O₃+Nb₂O₅+Ta₂O₅ is preferably 4% or less, more preferably 3% or less, still more preferably 2% or less, yet still more preferably 1% or less.

In addition, CeO₂ may be contained. CeO₂ may suppress coloration by oxidizing the glass. In the case of containing CeO₂, the content thereof is preferably 0.03% or more, more preferably 0.05% or more, still more preferably 0.07% or more. In order to increase the transparency, the content of CeO₂ is preferably 1.5% or less, more preferably 1.0% or less.

In the case of coloring the chemically strengthened glass, a coloring component may be added thereto within a range not hindering the achievement of desired chemical strengthening properties. Example of the coloring component include Co₃O₄, MnO₂, Fe₂O₃, NiO, CuO, Cr₂O₃, V₂O₅, Bi₂O₃, SeO₂, Er₂O₃, and Nd₂O₃.

The content of the coloring component is preferably 1% or less in total. In the case of wishing to increase the visible light transmittance of the glass more, it is preferable to be substantially free of these components.

In order to increase the weather resistance against ultraviolet irradiation, HfO₂, Nb₂O₅, and Ti₂O₃ may be added thereto. In the case of adding these components thereto for the purpose of increasing the weather resistance against ultraviolet irradiation, in order to reduce the influence on other properties, the total content of HfO₂, Nb₂O₅, and Ti₂O₃ is preferably 1% or less, more preferably 0.5% or less, still more preferably 0.1% or less.

In addition, SO₃, at least one of a chloride, and a fluoride may be appropriately contained as a refining agent, etc. at the time of melting of the glass. Since excessive addition affects the strengthening properties, the total content of the components functioning as a refining agent is, in mass % in terms of oxides, preferably 2% or less, more preferably 1% or less, still more preferably 0.5% or less. The lower limit is not particularly limited but is, typically, in mass % in terms of oxides, 0.05% or more in total.

In the case of using SO₃ as a refining agent, the effects are not seen when the content is too small, and therefore, the content of SO₃ is, in mass % in terms of oxides, preferably 0.01% or more, more preferably 0.05% or more, still more preferably 0.1% or more. In the case of using SO₃ as a refining agent, the content of SO₃ is, in mass % in terms of oxides, preferably 1% or less, more preferably 0.8% or less, still more preferably 0.6% or less.

In the case of using Cl as a refining agent, since excessive addition affects the physical properties such as strengthening properties, the content of Cl is, in mass % in terms of oxides, preferably 1% or less, more preferably 0.8% or less, still more preferably 0.6% or less. Also, in the case of using Cl as a refining agent, the effects are not seen when the content is too small, and therefore, the content of Cl is, in mass % in terms of oxides, preferably 0.05% or more, more preferably 0.1% or more, still more preferably 0.2% or more.

In the case of using SnO₂ as a refining agent, the content of SnO₂ is, in mass % in terms of oxides, preferably 1% or less, more preferably 0.5% or less, still more preferably 0.3% or less. Also, in the case of using SnO₂ as a refining agent, the effects are not seen when the content is too small, and therefore, the content of SnO₂ is, in mass % in terms of oxides, preferably 0.02% or more, more preferably 0.05% or more, still more preferably 0.1% or more.

P₂O₅ is preferably not contained. In the case of containing P₂O₅, the content thereof is preferably 2.0% or less, more preferably 1.0% or less, and it is most preferable not to contain P₂O₅.

As₂O₃ is preferably not contained. In the case of containing As₂O₃, the content thereof is preferably 0.3% or less, more preferably 0.1% or less, and it is most preferable not to contain As₂O₃.

<<Uses>>

Examples of uses of the present chemically strengthened glass include protective members for a sensor mounted on mobile equipment such as a car and a drone, for an outdoor sensor, and for a sensor mounted on a surveillance camera. The present chemically strengthened glass exhibits excellent resistance to flying stones and therefore, is preferably used, among those above, for a protective member of a sensor mounted on mobile equipment, more preferably for a protective member of an on-vehicle sensor. Each of FIGS. 1A and 1B is a perspective view illustrating a configuration example of a protective member formed with the present chemically strengthened glass as a part or the entirety.

FIG. 1A illustrates a structure where a protective glass 10 is used for a lid part of a cylindrical casing (protective member 1) accommodating a sensor 20, and FIG. 1B illustrates a structure where a glass is used for a spherical surface of a hemisphere accommodating the sensor 20. A part or the entirety of the protective member 1 is formed with the protective glass 10, and the present chemically strengthened glass can be used for the protective glass 10.

As for the protective member 1, as illustrated in FIG. 1A, a support part 2 for supporting the protective glass 10 may be formed in a part of the protective member 1. The support part 2 may be a glass, and also may be a metal such as stainless steel and alumite.

The protective member 1 is not limited to a cylindrical shape or a hemisphere and may have a columnar shape, a prismatic shape or a three-dimensional shape such as spherical regular polyhedron. In addition, the protective member 1 can be formed by laminating a plurality of glasses, and in the case of forming the support part 2, the support part 2 can be stuck to the protective glass 10 by forming an adhesive layer between the support part 2 and the protective glass 10.

<Method for Manufacturing Chemically Strengthened Glass>

The method for manufacturing a chemically strengthened glass of this embodiment (hereinafter, sometimes referred to as the present manufacturing method) includes performing a first ion exchange of exchanging ions by bringing a lithium-containing aluminosilicate glass having a sheet thickness of 1.4 to 7 mm into contact with a first inorganic salt composition containing sodium at a temperature of 430° C. or higher for 10 hours or longer.

The chemical strengthening treatment of forming a compressive stress layer in a glass surface layer is a treatment of bringing a glass sheet into contact with an inorganic salt composition to thereby exchange metal ions in the glass with metal ions existing in the inorganic salt composition and having a larger ionic radius than the metal ions in the glass.

Examples of the method for bringing the glass into contact with the inorganic salt composition include a method of applying a paste-like inorganic salt composition onto the glass, a method of spraying an aqueous solution of an inorganic salt composition on the glass, and a method of immersing a glass sheet in a salt bath of a molten salt of an inorganic salt composition, heated at a temperature of the melting point or higher. Among these, from the viewpoint of enhancing the productivity, a method of immersing the glass in a molten salt of an inorganic salt composition is preferred.

In the present specification, the “inorganic salt composition” refers to a composition containing a molten salt. Examples of the molten salt contained in the inorganic salt composition include nitrate, sulfate, carbonate, and chloride. Examples of the nitrate include lithium nitrate, sodium nitrate, potassium nitrate, cesium nitrate, rubidium nitrate, and silver nitrate. Examples of the sulfate include lithium sulfate, sodium sulfate, potassium sulfate, cesium sulfate, rubidium sulfate, and silver sulfate. Examples of the chloride include lithium chloride, sodium chloride, potassium chloride, cesium chloride, rubidium chloride, and silver chloride. These molten salts may be used individually, or a plurality kinds thereof may be used in combination.

As the inorganic salt composition, one having nitrate as a base is preferable; one having sodium nitrate or potassium nitrate as a base is more preferable. The expression “having something as a base” refers to the content in the inorganic salt composition being 80 mass % or more.

<<First Ion Exchange Treatment>>

The composition of the first inorganic salt composition used in the first ion exchange treatment is not particularly limited as long as the effects of the present invention are not impaired, but the composition contains sodium as an alkali metal ion having a larger ionic radius than lithium contained in a lithium-containing aluminosilicate glass. Examples of the inorganic salt containing sodium include sodium nitrate, sodium sulfate, and sodium chloride, and among these, sodium nitrate is preferred.

In the case where the first inorganic salt composition contains sodium nitrate, the content thereof is preferably 20 mass % or more, more preferably 30 mass % or more, still more preferably 50 mass % or more.

The first inorganic salt composition preferably contains lithium. Examples of the inorganic salt containing lithium include lithium nitrate, lithium sulfate, and lithium chloride, and among these, lithium nitrate is particularly preferred.

In the case of containing lithium nitrate in the first inorganic salt composition, the content thereof is preferably 0.01 mass % or more, more preferably 0.1 mass % or more, still more preferably 0.3 mass % or more. Also, the content is preferably 5 mass % or less, more preferably 4 mass % or less, still more preferably 3 mass % or less.

In the first ion exchange treatment, a lithium-containing aluminosilicate glass is brought into contact with the first inorganic salt composition at 430° C. or higher. In the case where the temperature of the first inorganic salt composition is 430° C. or higher, an ion exchange proceeds easily. The temperature is more preferably 435° C. or higher, still more preferably 440° C. or higher, yet still more preferably 445° C. or higher. Also, from the viewpoint of a risk due to evaporation and a constitutional change of the inorganic salt composition, the temperature of the first inorganic salt composition is usually 525° C. or lower.

In the first ion exchange treatment, the time for which the glass for chemical strengthening is brought into contact with the first inorganic salt composition is 10 hours or longer. By setting the contact time to be 10 hours or longer, the surface compressive stress can be increased. The contact time is more preferably, in sequence, 20 hours or longer, 40 hours or longer, 60 hours or longer, 80 hours or longer, still more preferably 90 hours or longer. In the case where the contact time is too long, not only the productivity decreases but also the compressive stress may be reduced due to a relaxation phenomenon. Therefore, the contact time is usually 200 hours or shorter.

In the present manufacturing method, the ion exchange treatment may be a treatment in one step or may be a treatment in two or more steps (multistep strengthening) under two or more different conditions.

<<Second Ion Treatment>>

In the case where the ion exchange treatment of the present manufacturing method is performed by multistep strengthening, it is preferable to include, after the first ion exchange, performing a second ion exchange of exchanging ions by bringing the lithium-containing aluminosilicate glass into contact with a second inorganic salt composition containing lithium.

The second inorganic salt composition is not particularly limited as long as it contains lithium and does not impair the effects of the present invention. Examples of the inorganic salt containing lithium include lithium nitrate, lithium sulfate, and lithium chloride, and among these, lithium nitrate is particularly preferred.

In the case of containing lithium nitrate in the second inorganic salt composition, the content thereof is preferably 0.01 mass % or more, more preferably 0.1 mass % or more, still more preferably 0.3 mass % or more. Also, the content is preferably 3 mass % or less, more preferably 2 mass % or less, still more preferably 1.5 mass % or less.

As the second inorganic salt composition, it is preferable to use a lithium-containing inorganic salt composition and, a potassium-containing inorganic salt composition or a sodium-containing inorganic salt composition in combination.

Examples of the potassium-containing inorganic salt composition used for the second inorganic salt composition include potassium nitrate, potassium sulfate, and potassium chloride, and among these, potassium nitrate is preferred.

In the case of containing potassium nitrate in the second inorganic salt composition, the content thereof is preferably 85 mass % or more, more preferably 90 mass % or more, still more preferably 95 mass % or more. Also, the content is preferably 99.9 mass % or less, more preferably 99.7 mass % or less, still more preferably 99.5 mass % or less.

Examples of the sodium-containing inorganic salt composition used for the second inorganic salt composition include sodium nitrate, sodium sulfate, and sodium chloride, and among these, sodium nitrate is preferred.

From the viewpoint of increasing the compressive stress in the deep layer portion, in the present chemical strengthening method, a ratio of lithium to the total amount of sodium and lithium contained in the second inorganic salt composition is preferably larger than a ratio of lithium to the total amount of sodium and lithium contained in the first inorganic salt composition.

From the viewpoint of increasing the ion exchange efficiency, in the second ion exchange treatment, the temperature of the second inorganic salt composition that is brought into contact with the lithium-containing aluminosilicate glass is preferably 400° C. or higher, more preferably 415° C. or higher, still more preferably 430° C. or higher, yet still more preferably 445° C. or higher. Also, from the viewpoint of a risk due to evaporation and a compositional change of the inorganic salt composition, the temperature of the second inorganic salt composition is, usually, preferably 505° C. or lower.

From the viewpoint of increasing the ion exchange efficiency, in the second ion exchange treatment, the time for which the glass for chemical strengthening is brought into contact with the second inorganic salt composition is preferably 1 hour or more, more preferably 4 hours or longer, still more preferably 8 hours or longer. In the case where the contact time is too long, not only the productivity decreases but also the compressive stress may be reduced due to a relaxation phenomenon. Therefore, the contact time is, usually, preferably 48 hours or shorter.

The second inorganic salt composition may contain a specific inorganic salt (hereinafter, referred to as flux) as an additive. Preferable examples of the flux include a carbonate, a hydrogencarbonate, a phosphate, a sulfate, a hydroxide, and a chloride. It is more preferable to contain at least one salt selected from the group consisting of K₂CO₃, Na₂CO₃, KHCO₃, NaHCO₃, K₃PO₄, Na₃PO₄, K₂SO₄, Na₂SO₄, KOH, NaOH, KCl, and NaCl, and it is still more preferable to contain at least one salt selected from the group consisting of K₂CO₃ and Na₂CO₃. The salt is yet still more preferably K₂CO₃.

Examples of the combination of the first inorganic salt composition used in the first ion exchange treatment and the second inorganic salt composition used in the second ion exchange treatment include the followings.
(a) The first inorganic salt composition is an inorganic salt composition containing mass % of sodium nitrate, and the second inorganic salt composition is an inorganic salt composition containing potassium and lithium.
(b) The first inorganic salt composition is an inorganic salt composition containing mass % of sodium nitrate, and the second inorganic salt composition is an inorganic salt composition containing a sodium salt and a lithium salt. The sodium salt contained in the second inorganic salt composition is preferably sodium nitrate, and the lithium salt contained in the second inorganic salt composition is preferably lithium nitrate.
(c) The first inorganic salt composition is an inorganic salt composition containing sodium nitrate and lithium nitrate, and the second inorganic salt composition is an inorganic salt composition containing potassium and lithium. The potassium salt contained in the second inorganic salt composition is preferably potassium nitrate, and the lithium salt contained in the second inorganic salt composition is preferably lithium nitrate.

<<Glass for Chemical Strengthening>>

The glass for chemical strengthening that is treated by the ion exchange in the present manufacturing method, is a lithium-containing aluminosilicate glass. The preferable composition of the lithium-containing aluminosilicate glass is the same as that described in the paragraph <<Composition>> of <Chemically Strengthened Glass>. That is, the base composition preferably contains, in mol % in terms of oxides, 52 to 75% of SiO₂, 8 to 20% of Al₂O₃, and 5 to 18% of Li₂O. The composition of the glass for chemical strengthening is consistent with the base composition of the chemically strengthened glass obtained by chemically strengthening the glass for chemical strengthening.

As for the method for manufacturing the glass for chemical strengthening, glass materials are appropriately mixed so that a glass having a desired composition can be obtained, and after heat-melting in a glass melting furnace, the glass is homogenized by bubbling, stirring, and addition of a refining agent, etc., then formed into a glass sheet having a predetermined thickness, and slowly cooled. Alternatively, the glass may be formed into a sheet shape by a method where the glass is formed in a block shape, then slowly cooled, and subsequently cut.

Examples of the method for forming the glass into a sheet shape include a float method, a press method, a fusion method, and a downdraw method. Particularly, in the case of manufacturing a large-size glass sheet, it is preferable to employ the float method. Continuous forming methods other than the float method, for example, the fusion method and the downdraw method are also preferable.

In the chemically strengthened glass obtained by the present manufacturing method, a compressive stress CS₄₀₀ at a depth of 400 μm from the surface is preferably 60 MPa or more, more preferably 70 MPa or more, still more preferably 80 MPa or more. In the case where CS₄₀₀ is 60 MPa or more, the compressive stress in the deep layer portion can be increased to enhance the resistance to flying stones more.

In the chemically strengthened glass obtained by the present manufacturing method, a compressive stress CS₅₀₀ at a depth of 500 μm from the surface is preferably 45 MPa or more, more preferably 50 MPa or more, still more preferably 55 MPa or more. In the case where CS₅₀₀ is 45 MPa or more, the compressive stress in the deep layer portion can be increased to enhance the resistance to flying stones more.

In the chemically strengthened glass obtained by the present manufacturing method, a compressive stress CS₆₀₀ at a depth of 600 μm from the surface is preferably 15 MPa or more, more preferably 20 MPa or more, still more preferably 25 MPa or more. In the case where CS₆₀₀ is 15 MPa or more, the compressive stress in the deep layer portion can be increased to enhance the resistance to flying stones more.

### EXAMPLES

The present invention is described below by referring to Examples, but the present invention is not limited thereto.

<Manufacture of Glass for Chemical Strengthening>

Glass raw materials were prepared to have the following composition represented by molar percentage in terms of oxides and weighed to make 400 g as glass. Subsequently, the mixed raw materials were put in a platinum crucible, placed into an electric furnace at 1,500 to 1,700° C., melted for about 3 hours, degassed and homogenized.

Glass Material A: SiO₂ 66.2%, Al₂O₃ 11.2%, MgO 3.1%, CaO 0.2%, ZrO₂ 1.3%, Y₂O₃ 0.5%, Li₂O 10.4%, Na₂O 5.6%, K₂O 1.5%

The molten glass obtained was poured into a metal mold, held for 1 hour at a temperature about 50° C. higher than the glass transition temperature, and then cooled to room temperature at a rate of 0.5° C./min to obtain a glass block. A glass sheet of (sheet thickness (mm) shown in Table 1)×50 mm×50 mm was made from the obtained glass block.

<Chemical Strengthening Treatment and Evaluation of Chemically Strengthened Glass>

Using the glass sheet obtained above, the first ion exchange treatment and the second ion exchange treatment were applied thereto by immersing the glass sheet in a molten salt composition under the conditions shown in Table 1, and chemically strengthened glasses of Examples 1 to 13 were thus manufactured. Examples 1 to 3, 8, 9 and 11 to 13 are Inventive Examples, and Examples 4 to 7 and 10 are Comparative Examples.

The chemically strengthened glasses obtained were evaluated by the following method.

[Stress Measurement by Scattered Light Photoelastic Stress Meter]

The stress of the chemically strengthened glass was measured using scattered light photoelastic stress meter (SLP-2000 manufactured by Orihara Manufacturing Co., Ltd.) according to the method described in WO2018/056121. In addition, the stress profile was computed using the software [SlpV (Ver. 2019.11.07.001)] attached to the scattered light photoelastic stress meter (SLP-2000 manufactured by Orihara Manufacturing Co., Ltd.).

The function used for obtaining the stress profile is σ(x)=[a₁×erfc(a₂×x)+a₃×erfc(a₄×x)+a₅], where aᵢ (i=1 to 5) represents a fitting parameter, and erfc represents a complementary error function. The complementary error function is defined by the following expression.

$$\begin{matrix}erfc ( x ) = 1 - erf ( x ) \\ = \frac{2}{\sqrt{π}} {\int }_{x}^{∞} {e}^{- {t}^{2}} d t = {e}^{- {x}^{2}} erfc x ( x )\end{matrix}$$

In the evaluation of the present specification, the residual sum of squares between the obtained raw data and the above-described function was minimized to optimize the fitting parameters. Individual items were set by designation or selection in the following manner: measurement processing condition was obtained by single shot; measurement region processing adjustment item was an edge method in the surface; internal surface edge was 6.0 μm; internal left-right edge was automatic; internal deep portion edge was automatic (center of sample film thickness); and elongation of a phase curve to the center of a sample thickness was a fitting curve.

At the same time, a concentration distribution of alkali metal ions (sodium ions and potassium ions) in a sectional direction was measured by SEM-EDX (SPMA) and confirmed to be consistent with the obtained stress profile.

In addition, from the obtained stress profile, the values of the compressive stress CS and the depth of compressive stress layer DOC were computed by the above-described methods. The results are shown in Table 1.

In Table 1, respective notations indicate the followings:

Li/Li+Na in salt: a mass ratio of lithium to the total amount of sodium and lithium contained in the inorganic salt composition

CS₀ (MPa): a compressive stress in a surface of the glass

CS₄₀₀ (MPa): a compressive stress at a depth of 400 μm from a surface of the glass

CS₅₀₀ (MPa): a compressive stress at a depth of 500 μm from a surface of the glass

CS₆₀₀ (MPa): a compressive stress at a depth of 600 μm from a surface of the glass

Surface layer slope: a negative maximum slope (MPa/μm) of a stress profile at a depth of 0 to 20 μm from a surface of the glass

Deep layer slope: a negative maximum slope (MPa/μm) of a stress profile at a position deeper than a depth of 50 μm from a surface of the glass

Local maximum CS₁p: a compressive stress value at the local maximum

Local maximum position d: a depth (μm) from a surface having a compressive stress value at the local maximum

d/t: a value obtained by dividing a depth from a surface having a compressive stress value at the local maximum, by a sheet thickness t

ms: an absolute value (MPa/μm) of a positive average slope on a side shallower than the local maximum

md: an absolute value (MPa/μm) of a negative average slope on the side deeper than the local maximum

DOC: a depth of a compressive stress layer (μm)

DOC/t: a value obtained by dividing a depth of a compressive stress layer by a sheet thickness t

CTmax (MPa): a maximum tensile stress

DOL@50 MPa: a stress layer depth (μm) from a surface, where a compressive stress becomes 50 MPa

ICS (≥400): an integrated value (MPa·μm) of a compressive stress in a region from a depth of 400 μm from a surface to a depth where a compressive stress becomes 0 ICS: an integrated value (MPa·μm) of compressive stress CS

[Flying Stone Test]

The crack generation rate was calculated (n≥3) by performing a flying stone test under the following conditions in accordance with the strength test method of ISO 20567-1 Test Method B. Evaluation was performed according to the following indices, and the results are shown in Table 1.

### (Conditions)

Flying stone: chilled iron grit
Stone size: 3.55-5 mm
Ejection amount: 500 g
Ejection pressure: 250 kPa
Sample setting angle: 54°
Ejection time: 8-12 seconds
Number of ejections: 2
Sample collision area: 40-40 mm

### (Evaluation Indices)

AA: The crack generation rate was 0%.
A: The crack generation rate was 10% or more and less than 20%.
B: The crack generation rate was 20% or more and less than 60%.
C: The crack generation rate was 60% or more and 100% or less.

TABLE 1

| | | | Ex. 1 | Ex. 2 | Ex. 3 | Ex. 4 | Ex. 5 |
|---|---|---|---|---|---|---|---|
| Glass material | | | A | A | A | A | A |
| Sheet thickness (mm) | | | 3.5 | 3.5 | 3.5 | 3.5 | 3.5 |
| Strengthening | Primary | Salt concentration | 100%NaNO₃ | 99%NaNO₃ + | 100%NaNO₃ | 99%NaNO₃ + | 100%NaNO₃ |
| conditions | strengthening | (mass %) | | 1%LiNO₃ | | 1%LiNO₃ | |
| | | Temperature, time | 450° C. 96 hr | 450° C. 96 hr | 450° C. 96 hr | 450° C. 144 hr | 450° C. 96 hr |
| | | Li/Li + Na in salt | 0 | 0.004 | 0 | 0.004 | 0 |
| | Secondary | Salt concentration | 99%KNO₃ + | 99%KNO₃ + | 99%NaNO₃ + | — | — |
| | strengthening | (mass %) | 1%LiNO₃ | 1%LiNO₃ | 1%LiNO₃ | | |
| | | Temperature, time | 450° C. 12 hr | 450° C. 24 hr | 450° C. 12 hr | — | — |
| | | Li/Li + Na in salt | 1 | 1 | 0.004 | — | — |
| Stress | CS₀ | MPa | 545 | 574 | 256 | 230 | 321 |
| characteristic | DOL₅₀ | μm | 543 | 529 | 489 | 468 | 475 |
| value | CS₄₀₀ | MPa | 92 | 63 | 83 | 71 | 81 |
| | CS₅₀₀ | MPa | 63 | 54 | 46 | 41 | 41 |
| | CS₆₀₀ | MPa | 34 | 39 | 15 | 15 | 9 |
| | CS₄₀₀/CS₀ | | 0.17 | 0.11 | 0.32 | 0.31 | 0.25 |
| | CS₆₀₀/CS₀ | | 0.06 | 0.07 | 0.03 | 0.03 | 0.02 |
| | Surface layer slope | MPa/μm | −26.5 | −11.4 | — | — | — |
| | Deep layer slope | MPa/μm | −0.3 | −0.19 | −0.45 | −0.43 | −0.68 |
| | Local maximum CSlp | MPa | 118 | 64 | — | — | — |
| | Local maximum | μm | 240 | 345 | — | — | — |
| | position d | | | | | | |
| | d/t | | 0.069 | 0.099 | — | — | — |
| | Absolute value ms | MPa/μm | 0.36 | 0.13 | — | — | — |
| | of positive average | | | | | | |
| | slope on the side | | | | | | |
| | shallower than | | | | | | |
| | maximum value | | | | | | |
| | Absolute value md | MPa/μm | 0.12 | 0.09 | | | |
| | of negative average | | | | | | |
| | slope on the side | | | | | | |
| | deeper than | | | | | | |
| | maximum value | | | | | | |
| | DOC | μm | 749 | 808 | 657 | 672 | 634 |
| | DOC/t | | 0.214 | 0.23 | 0.187 | 0.192 | 0.181 |
| | CTmax | MPa | 61 | 68 | 57 | 60 | 58 |
| | ICS(≥400) | MPa · μm | 15001 | 14649 | 9826 | 8881 | 8588 |
| | ICS | MPa · μm | 53210 | 34747 | 77025 | 67613 | 64038 |
| | ICS(≥400)/ICS | | 0.28 | 0.42 | 0.14 | 0.13 | 0.13 |
| Flying stone | Crack generation rate | % | 0 | 0 | 0 | 20 | 80 |
| test | Rating | | AA | AA | AA | B | C |

| | | | Ex. 6 | Ex. 7 | Ex. 8 | Ex. 9 | Ex. 10 |
|---|---|---|---|---|---|---|---|
| Glass material | | | A | A | A | A | A |
| Sheet thickness (mm) | | | 3.5 | 4 | 4 | 4 | 5 |
| Strengthening | Primary | Salt concentration | 99%NaNO₃ + | 99%NaNO₃ + | 99%NaNO₃ + | 100%NaNO₃ | 100%NaNO₃ |
| conditions | strengthening | (mass %) | 1%LiNO₃ | 1%LiNO₃ | 1%LiNO₃ | | |
| | | Temperature, time | 450° C. 200 hr | 450° C. 48 hr | 450° C. 144 hr | 450° C. 96 hr | 450° C. 48 hr |
| | | Li/Li + Na in salt | 0.004 | 0.004 | 0.004 | 0 | 0 |
| | Secondary | Salt concentration | | | | 99.2%NaNO₃ + | |
| | strengthening | (mass %) | | | | 0.8%LiNO₃ | |
| | | Temperature, time | — | — | — | 450° C. 12 hr | — |
| | | Li/Li + Na in salt | — | — | — | 1 | — |
| Stress | CS₀ | MPa | 211 | 280 | 248 | 542 | 334 |
| characteristic | DOL₅₀ | μm | 467 | 446 | 534 | 581 | 487 |
| value | CS₄₀₀ | MPa | 69 | 67 | 91 | 102 | 85 |
| | CS₅₀₀ | MPa | 41 | 32 | 60 | 73 | 45 |
| | CS₆₀₀ | MPa | 17 | 5 | 32 | 45 | 15 |
| | CS₄₀₀/CS₀ | | 0.33 | 0.24 | 0.37 | 0.19 | 0.26 |
| | CS₆₀₀/CS₀ | | 0.04 | 0.01 | 0.06 | 0.08 | 0.03 |
| | Surface layer slope | MPa/μm | — | — | — | −23.6 | — |
| | Deep layer slope | MPa/μm | −0.39 | −0.61 | −0.42 | −0.30 | −0.72 |
| | Local maximum CSlp | MPa | — | — | — | 117 | — |
| | Local maximum | μm | | | | 215 | |
| | position d | | | | | | |
| | d/T | | | | | 0054 | |
| | Absolute value ms | MPa/μm | — | — | — | 0.22 | — |
| | of positive average | | | | | | |
| | slope on the side | | | | | | |
| | shallower than | | | | | | |
| | maximum value | | | | | | |
| | Absolute value md | MPa/μm | — | — | — | 0.12 | — |
| | of negative average | | | | | | |
| | slope on the side | | | | | | |
| | deeper than | | | | | | |
| | maximum value | | | | | | |
| | DOC | μm | 686 | 621 | 752 | 786 | 668 |
| | DOC/t | | 0.196 | 0.155 | 0.188 | 0.196 | 0.134 |
| | CTmax | MPa | 59 | 50 | 47 | 79 | 40 |
| | ICS(≥400) | MPa · μm | 9109 | 6716 | 14443 | 18634.01 | 9902 |
| | ICS | MPa · μm | 85931 | 73233 | 61988 | 66228 | 90081 |
| | ICS(≥400)/ICS | | 0.11 | 0.09 | 0.23 | 0.28 | 0.11 |
| Flying stone | Crack generation rate | % | 60 | — | 10 | — | — |
| test | Rating | | C | C | A | AA | C |

| | | | Ex. 11 | Ex. 12 | Ex. 13 |
|---|---|---|---|---|---|
| Glass material | | | A | A | A |
| Sheet thickness (mm) | | | 5 | 5 | 5 |
| Strengthening | Primary | Salt concentration | 100%NaNO₃ | 100%NaNO₃ | 100%NaNO₃ |
| conditions | strengthening | (mass %) | | | |
| | | Temperature, time | 450° C. 96 hr | 450° C. 144 hr | 450° C. 144 hr |
| | | Li/Li + Na in salt | 0 | 0 | 0 |
| | Secondary | Salt concentration | | | 99.2%KNO₃ + |
| | strengthening | (mass %) | | | 0.8%LiNO₃ |
| | | Temperature, time | — | — | 450° C. 24 hr |
| | | Li/Li + Na in salt | — | — | 1 |
| Stress | CS₀ | MPa | 291 | 270 | 563 |
| characteristic | DOL₅₀ | μm | 583 | 628 | 702 |
| value | CS₄₀₀ | MPa | 110 | 116 | 91 |
| | CS₅₀₀ | MPa | 75 | 85 | 82 |
| | CS₆₀₀ | MPa | 45 | 57 | 68 |
| | CS₄₀₀/CS₀ | | 0.38 | 0.43 | 0.16 |
| | CS₆₀₀/CS₀ | | 0.08 | 0.09 | 0.10 |
| | Surface layer slope | MPa/μm | — | — | −16.6 |
| | Deep layer slope | MPa/μm | −0.49 | −0.41 | −0.19 |
| | Local maximum CSlp | MPa | — | — | 93 |
| | Local maximum | μm | | | 334 |
| | position d | | | | |
| | d/t | | | | 0.0668 |
| | Absolute value ms | MPa/μm | — | — | 0.10 |
| | of positive average | | | | |
| | slope on the side | | | | |
| | shallower than | | | | |
| | maximum value | | | | |
| | Absolute value md | MPa/μm | — | — | 0.07 |
| | of negative average | | | | |
| | slope on the side | | | | |
| | deeper than | | | | |
| | maximum value | | | | |
| | DOC | μm | 817 | 885 | 972 |
| | DOC/t | | 0.163 | 0.177 | 0.194 |
| | CTmax | MPa | 43 | 48 | 64 |
| | ICS(≥400) | MPa · μm | 19601 | 24411 | 28896 |
| | ICS | MPa · μm | 98090 | 100645 | 62348 |
| | ICS(≥400)/ICS | | 0.20 | 0.24 | 0.46 |
| Flying stone | Crack generation rate | % | — | — | — |
| test | Rating | | A | A | AA |

As shown in Table 1, in each of Examples 1 to 3, 8, 9 and 11 to 13 that are Inventive Examples, compared with Comparative Examples, the compressive stress in the deep layer portion at the depth of 400 μm or more from the surface was high, and excellent resistance to flying stones was exhibited.

### REFERENCE SIGNS LIST

1 Protective member
2 Support part
5 Mounting part
10 Protective glass
20 Sensor
30 Camera

What is claimed is:

1. A chemically strengthened glass, satisfying:
a ratio ICS (≥400)/ICS being more than 0.13 in a stress profile, the ICS representing an integrated value of compressive stress in a region from a surface of the glass to a depth where the compressive stress becomes 0 in the stress profile, and the ICS (≥400) representing an integrated value of compressive stress in a region from a depth of 400 μm from the surface of the glass to the depth where the compressive stress becomes 0 in the stress profile.

2. The chemically strengthened glass according to claim 1, wherein the ICS (≥400) is 9,200 MPa·μm or more.

3. The chemically strengthened glass according to claim 1, having a stress layer depth DOL where the compressive stress becomes 50 MPa of 400 μm or more.

4. The chemically strengthened glass according to claim 1, having a negative maximum slope of the stress profile at a position deeper than 50 μm from the surface of −0.50 (MPa/μm) or more.

5. The chemically strengthened glass according to claim 1, having a value DOC/t being 0.170 or more, the DOC representing a depth of a compressive stress layer, and the t representing a sheet thickness of the glass.

6. The chemically strengthened glass according to claim 1, having a maximum tensile stress CTmax of 40 MPa or more.

7. The chemically strengthened glass according to claim 1, having a compressive stress CS₆₀₀ at a depth of 600 μm from the surface of 15 MPa or more.

8. The chemically strengthened glass according to claim 1, having a negative maximum slope of the stress profile at a depth of 0 to 20 μm from the surface of −10 (MPa/μm) or less.

9. The chemically strengthened glass according to claim 1, wherein the stress profile has a local maximum, and the compressive stress value at the local maximum is 50 MPa or more.

10. The chemically strengthened glass according to claim 9, wherein the local maximum positions within a range of 0.05 t to 0.13 t in a depth from the surface, t representing a sheet thickness of the glass.

11. The chemically strengthened glass according to claim 9, satisfying:
a relationship of ms>md, the ms representing an absolute value of an average slope of the stress profile in a region from the surface to the local maximum; and the and representing an absolute value of an average slope of the stress profile from the local maximum to the depth where the compressive stress becomes 0.

12. The chemically strengthened glass according to claim 1, having a ratio CS₄₀₀/CS₀ being 0.10 or more, the CS₄₀₀ representing a compressive stress at a depth of 400 μm from the surface, and CS₀ representing a surface compressive stress.

13. The chemically strengthened glass according to claim 1, having a ratio CS₆₀₀/CS₀ being 0.03 or more, the CS₆₀₀ representing a compressive stress at a depth of 600 μm from the surface, and CS₀ representing a surface compressive stress.

14. The chemically strengthened glass according to claim 1, having a ratio CS₄₀₀/CS₀ being 0.32 or more, the CS₄₀₀ representing a compressive stress at the depth of 400 μm from the surface, and CS₀ representing a surface compressive stress.

15. The chemically strengthened glass according to claim 1, having a crack generation rate evaluated in accordance with a strength test method of ISO 20567-1 Test Method B of 10% or less.

16. The chemically strengthened glass according to claim 1, having a sheet thickness of the glass of 1.4 to 7 mm.

17. The chemically strengthened glass according to claim 1, being used for an on-vehicle sensor.

18. A method for manufacturing a chemically strengthened glass, comprising:
performing a first ion exchange of exchanging ions by bringing a lithium-containing aluminosilicate glass having a sheet thickness of 1.4 to 7 mm into contact with a first inorganic salt composition containing sodium at a temperature of 430° C. or higher for 10 hours or longer.

19. The method for manufacturing a chemically strengthened glass according to claim 18, wherein the chemically strengthened glass has a compressive stress CS₄₀₀ at a depth of 400 μm from a surface of the glass of 60 MPa or more.

20. The method for manufacturing a chemically strengthened glass according to claim 18, further comprising, after the first ion exchange, performing a second ion exchange of exchanging ions by bringing the lithium-containing aluminosilicate glass into contact with a second inorganic salt composition containing lithium.

21. The method for manufacturing a chemically strengthened glass according to claim 20, wherein the second inorganic salt composition comprises lithium and potassium.

22. The method for manufacturing a chemically strengthened glass according to claim 20, wherein a mass ratio of lithium to a total amount of sodium and lithium contained in the second inorganic salt composition is larger than a mass ratio of lithium to a total amount of sodium and lithium contained in the first inorganic salt composition.
